(19) United States
(12) Patent Application Publication
(10) Pub. No.: US 2001/0036558 A1
(43) Pub. Date: Nov. 1, 2001

(54) Laminar articles containing layers of ethylene containing polymer elastomers containing resins

(76) Inventors: Kenneth Lewtas, Tervuren (BE); Vincent B.B.G. Gallez, Mont-Saint-Guibert (BE); Eric P. Jourdain, Rhode Saint Genese (BE); Thomas Jay Reynolds, Houston, TX (US); Giandomenico Stella, Brussels (BE)

Correspondence Address: ExxonMobil Chemical Company, P.O. Box 2149, Baytown, TX, 77522, US

(21) Appl. No.: 09/759,663

(22) Filed: Jan. 12, 2001

Related U.S. Application Data
(60) Provisional application No. 60/184,609, filed on Feb. 24, 2000.

(30) Foreign Application Priority Data
Jan. 14, 2000 (GB) 0000674.2

(51) Int. Cl. B32B 27/32

(52) U.S. Cl. 428/521; 525/210; 525/211; 524/274; 428/516; 428/517; 428/519; 474/238; 474/242; 293/20

(57) ABSTRACT

Multilayer articles such as V-belts, hoses, rubber sheets, tires are produced from ethylene, alpha-olefin, or ethylene, alpha olefin diene copolymer elastomers which despite their attractive properties, have not been used previously due to the lack of green tack. The problem of insufficient green tack is overcome by the incorporating an aromatic containing petroleum resin.

This Application claims priority to Great Britain Application 0000674.2 filed Jan. 14, 2000 and U.S. Ser. No. Provisional Application 60/184,609 filed Feb. 24, 2000.

### FIELD OF INVENTION

The present invention relates to laminar articles containing elastomer compositions with improved green tack, in particular elastomer compositions with sufficient tack to form integral structures of sufficient strength to enable vulcanization without the need for adhesives. Green tack is the term given to the adhesive properties of a vulcanizable rubber product prior to vulcanization.

### BACKGROUND INFORMATION

Natural and synthetic rubbers and elastomers are used extensively in the production of multi-layer articles such as V-belts, hoses, sheets such as those used for roofing, mats and tires. Examples of materials that are used are chloroprene, natural rubbers and synthetic rubbers such as neoprene, butyl rubber, styrene butadiene rubbers and polydiene rubbers. Typically the rubber compounds are produced by calendaring and mixing to thoroughly disperse additives such as fillers, pigments, antioxidants and vulcanizing agents throughout the rubber. Once the compound is formed, the final articles are produced by forming layers, laying up and vulcanizing or by co-extrusion and subsequent vulcanization. Typical manufacturing processes for V-belts comprise producing laminated strips of the belting material, usually a laminar structure, laying the strips around a drum and then vulcanizing. It is therefore important that the layers in the laminar structure have sufficient green tack to adhere to each other and to firmly bond the two ends of the strips together.

Similarly rubbers are used in the production of tires. A tire is an assembly of different rubber layers, each performing a particular function, reinforced by textile and/or steel cords and mounted on a ring. In tire manufacture the rubber layer is laid against the other layers of the tire and the tire vulcanized to form an integral structure. Here again, it is important that the rubber layers have sufficient green tack to adhere to the other layers prior to vulcanization.

Hoses are typically multilayer products produced by co-extrusion and subsequent vulcanization. Generally there is a storage period between co-extrusion and autoclave vulcanization and green tack is important to retain an integral structure during storage.

Chloroprenes are often used in these articles because the presence of the chlorine imparts sufficient adhesion prior to vulcanization. The presence of chlorine is however undesirable from an environmental point of view and because it leads to poor ageing of the rubber. Where other elastomers have been used, adhesives have been used to hold the components together prior to vulcanization, such as for example, in European Patent 195273. The use of adhesives is costly, requires another step in the manufacturing process and can result in failures and weaknesses in the finished product.

Ethylene copolymer or terpolymer elastomers are attractive materials for the production of articles such as V-belts, hoses, mats and tires due to their combined barrier, elastomeric and resilience properties, they would be particularly useful in the manufacture of tires in view of their good ozone resistance. They have not however, been used since they do not have sufficient green tack to enable the formation of a sufficient bond to form an integral structure with the other layers prior to vulcanization.

It has been proposed in European Patent Application 0685511 A, that hydrogenated petroleum resins may be incorporated into hydrocarbon rubbers such as ethylene, propylene copolymer rubber, ethylene propylene diene copolymer rubber, natural rubber, isoprene rubber, styrene butadiene copolymer rubber and butadiene rubber, to enhance processing. The rubber is said to have insufficient adhesion, an excessively high viscosity, to wrap around the roll during processing and to give a vulcanite poor in adhesion. EP 0685511 sets out to overcome the problem that although tackifiers can improve processability, they adversely affect the vulcanizate in physical properties and heat resistance, the problem is said to be overcome by the use of hydrogenated petroleum resins.

Accordingly EP 0685511 is not concerned with green tack but with rubber processing and the properties of vulcanizates. The present invention on the other hand is concerned with the development of green tack in ethylene, α-olefin copolymer rubbers and ethylene, α-olefin, diene copolymer rubbers. In particular in ethylene propylene copolymer rubbers and ethylene, propylene diene copolymer rubbers.

### SUMMARY OF THE INVENTION

We have however now found that layers of an ethylene, α-olefin, copolymer rubber or an ethylene, α-olefin diene elastomeric terpolymer containing aromatic hydrocarbon resins have sufficient green tack to enable the formation of integral structures of sufficient strength for subsequent vulcanization without the need for additional adhesives.

The invention therefore provides a multilayer structure containing at least one layer containing a blend of an ethylene, α-olefin, copolymer and/or an ethylene, α-olefin diene elastomeric terpolymer and an aromatic containing hydrocarbon resin.

The invention further provides the use of an aromatic containing hydrocarbon resin for the development of green tack in ethylene α-olefin copolymer rubber and/or ethylene, α-olefin diene terpolymer rubbers.

The invention further provides a process for the production of a rubber compound comprising an ethylene, α-olefin copolymer rubber and/or an ethylene, α-olefin diene terpolymer rubber containing an aromatic hydrocarbon resin in which the rubber is first compounded with other additives and the aromatic hydrocarbon resin added no sooner than half way through the compounding cycle.

The invention further provides a process for the production of multilayer articles comprising producing a layer containing an ethylene α-olefin copolymer rubber and/or an ethylene, α-olefin diene copolymer rubber and an aromatic petroleum resin laying the layer against a second layer and optionally vulcanising the composite structure.

### DETAILED DESCRIPTION OF THE INVENTION

The ethylene containing elastomeric polymers used in this invention are polymers that have been copolymerized with one or more higher alpha olefin monomers optionally with a diene monomer. As applied to these polymers, the terms “elastomeric” or “elastomer” are defined to mean that when they are crosslinked they are capable of recovering from large deformations quickly and forcibly. Free from diluents, the crosslinked polymers retract within one minute to less than 1.5 times their original lengths after being stretched at 18° C.-29° C. to twice their lengths and held for one minute before release.

The ethylene containing elastomeric polymer will also include one or more higher mono-olefins, particularly α-olefins having from 3 to 25 carbon atoms. The higher mono-olefins suitable for use may be branched or straight chain, cyclic and aromatic substituted or unsubstituted, and are preferably α-olefins having from 3 to 16 carbon atoms. Illustrative non-limiting examples of preferred α-olefins are propylene, 1-butene, 1-pentene, 1-hexene, 1-octene and 1-dodecene. Mixed olefins can also be used (e.g. propylene and 1-butene, mixed butenes etc).

The α-olefin is generally incorporated into the ethylene containing elastomeric polymer in an amount of about 15 to about 85 wt %, more preferably at about 15 to about 70 wt % and even more preferably about 20 to about 60 wt %.

Illustrative of such substituted α-olefins are compounds of the formula H₂C═CH−CₙH_{zn}—X′ wherein n is an integer from 1 to 20 (preferably 1 to 10), and X′ comprises aryl, alkylaryl or cycloalkyl. Also useful are α-olefins substituted by one or more such X′ substituents wherein the substituent(s) are attached to a non-terminal carbon atom, provided that the substituted carbon atom is not in the 1- or 2-carbon position in the olefin. Included are the alkyl-substituted bicyclic and bridged alpha-olefins, of which C₁-C₉ alkyl substituted norbornenes are preferred (e.g. 5-methyl-2-norbornene, 5-ethyl-2-norbornene, 5-(2′-ethylhexyl)-2-norbornene, vinyl norbornene and the like).

Non-conjugated dienes suitable for production of the diene containing polymers used in the present invention can be straight chain, hydrocarbon di-olefins or cycloalkyenyl-substituted alkenes, having 6 to 15 carbon atoms. Of these, the preferred dienes are dicyclopentadiene, 1,4-hexadiene, 5-methylene-2-norbornene, and 5-ethylidene-2-norbornene. Particularly preferred dienes are 5-ethylidene-2-norbornene and 1,4-hexadiene. It will be apparent that a mix of such dienes can also be used. The content of the optional diene monomer in the ethylene-containing elastomeric polymer can be 0.5 to 15 wt %, and if used preferably 0.5 to 12 wt %, and most preferably 1.0 to about 6.0 wt %.

The molecular weight range of the ethylene containing polymers as measured by NMR will typically range from 5,000 to 5,000,000 weight average molecular weight (Mw), more typically from 10,000 to 500,000 Mw, most typically 15,000 to 350,000 Mw. Mooney viscosity (ML₁₊₄, 125° C.) will typically range from 10 up to 90, more typically 20 to 75.

The elastomers may be prepared in conventional polymerisation reactors, the polymerisation reaction can be carried out at any temperature suitable for Ziegler catalysts, including traditional Ziegler-Natta catalysts and newer Group 3-10 transition metal single-site catalysts (metallocenes, bisimido and bisamido structural counterparts, etc.), such as a temperature of about −100° C. to about 150° C., or preferably about 10° C. to about 100° C. and more preferably about 0° C. to about 60° C. The pressure used in the polymerisation process can vary from about 0 Kpa to about 600 Kpa. Alternatively metallocene catalysts may be used to produce the elastomers, as is described, e.g., U.S. Pat. Nos. 5,837,787; 5,625,016; 5,696,213 and PCT publications WO 99/45047 and WO 99/45049 all incorporated herein by reference.

Any known diluent or solvent for the reaction mixture that is effective for the purpose can be used in conducting polymerisation. For example, suitable diluents or solvents are hydrocarbon solvents such as aliphatics, cyclo-aliphatics and aromatic hydrocarbon solvents, or halogenated versions of such solvents.

Additionally, it is known to incorporate “branch suppressers” to reduce branching. It is known in the art that certain Lewis bases, such as NH₃ are effective branch suppressers. Additionally, certain alkoxy silanes e.g., methyl silicate (Si(OMe)₄), ethyl silicate (Si(OEt)₄), etc. have been recently discovered to act as effective branch suppressers without reducing catalyst efficiency or reactivity. Thus, the catalyst system of this invention may be used in any of the known solution polymerisation processes.

After polymerisation, the polymerisation reaction mixture is quenched by known methods at the exit of the reactor. This quenching can be accomplished by the introduction into the polymerisation reaction mixture (e.g. into the polymerisation product effluent stream) of water, lower alcohol, or aqueous acid (e.g. aqueous HCl) as quench liquid.

A process for the production of the elastomeric product is described in U.S. Pat. No. 4,540,753. As indicated therein, the processes are carried out in a “mix-free reactor”, where substantially no mixing occurs between portions of the reaction mixture that contain polymer chains initiated at different times. This typically tubular reactor polymerisation provides for substantially no “back-mixing” and substantially no mixing in an axial direction. Another preferred manufacturing process and preferred elastomers are described in European Patent Application 0227206 A, incorporated herein by reference.

The aromatic containing hydrocarbon resins, which may be used in the blends of the present invention, may be obtained by the polymerisation of petroleum feedstreams, which contain mixtures of monomers. Alternatively, they may be produced by the polymerisation of pure aromatic monomers. The resins may also be obtained by the blending of resins such as an aromatic containing resin and an aromatic free resin, or two resins of different aromatic levels, in order to obtain the desired aromatic level in the blend of the invention.

Typical feedstreams include between 20 wt % and 80 wt % monomers and 80 wt % to 20 wt % of solvent. Preferably, the feedstream includes 30 wt % to 70 wt % monomers and 70 wt % to 30 wt % of solvent. More preferably, the feedstream includes about 50 wt % to 70 wt % monomers and 50 wt % to 30 wt % of solvent. The solvent may include an aromatic solvent. The aromatic solvent may include at least one of toluene, xylenes, and aromatic petroleum solvents. The solvent may include an aliphatic solvent. The solvent may be the unpolymerizable component in the feed.

Typically aliphatic feeds contain at least C₅ monomers and cyclopentadiene and methylcyclopentadiene components may be removed from the feedstream by heating at a temperature between 100° C. and 160° C. and fractionating by distillation. The C₅ monomers may include at least one member selected form the group consisting of butadiene, isobutylene, 2-methyl-2-butene, 1-pentene, 2-methyl-1-pentene, 2-methyl-2-pentene, 2-pentene, cyclopentene, cyclohexene, 1,3-pentadiene, 1,4-pentadiene, isoprene, 1,3-hexadiene, 1,4-hexadiene, cyclopentadiene, and dicyclopentadiene. The feedstream may include at least C₅ monomers, wherein the feedstream includes at least 70 wt % of polymerizable monomers with at least about 50 wt % 1,3-pentadiene. The feedstream may contain low levels of isoprene, generally contains a portion of 2-methyl-2-butene, and may contain one or more cyclodiolefins.

The feedstream may further include up to 40 wt % of chain transfer agent, preferably up to 20 wt % of chain transfer agent. The chain transfer agent may include at least one member selected from the group consisting of C₄ olefins, C₅ olefins, dimers of C₄ olefins, and dimers of C₅ olefins. The chain transfer agent may include at least one member selected from the group consisting of isobutylene, 2-methyl-1-butene, 2-methyl-2-butene, dimers thereof, and oligomers thereof

In accordance with another aspect, the feedstream includes 30 wt % to 95 wt % of C₅ monomers and 70 wt % to 5 wt % of a co-feed including at least one member selected from the group consisting of pure monomer, C₉ monomers, and terpenes. Preferably, the feedstream includes 50 wt % to 85 wt % of C₅ monomers and 50 wt % to 15 wt % of a co-feed including at least one member selected from the group consisting of pure monomer, C₉ monomers, and terpenes. The pure monomer is preferably an aromatic monomer, such as styrene, α-methyl styrene or vinyl toluene.

Where the feedstream includes at least C₉ aromatic monomers, the C₉ monomers may include at least one member selected from the group consisting of styrene, vinyl toluene, indene, dicyclopentadiene, and alkylated derivatives thereof. The C₉ monomers may include at least 20 wt % polymerizable unsaturated hydrocarbons. The C₉ monomers may include 30 wt % to 75 wt % polymerizable unsaturated hydrocarbons. The C₉ monomers may include 35 wt % to 70 wt % polymerizable unsaturated hydrocarbons.

Pure monomer feedstreams may contain relatively pure styrene-based monomers such as styrene, alpha-methyl styrene, beta-methyl styrene, 4-methyl styrene, and vinyl toluene fractions. The monomers can be used as pure components or as blends of two or more monomer feeds to give desired resin properties. Preferred blends include 20 wt % to 90 wt % alpha-methyl styrene with 80 wt % to 10 wt % of one or more co-monomers, preferably styrene, vinyl toluene, 4-methyl styrene or blends of these components. In addition, other alkylated styrenes can be used as monomers in this invention such as t-butyl styrene or phenyl styrene.

In yet another aspect, the feedstream includes 30 wt % to 95 wt % of the C₉ monomers and 70 wt % to 5 wt % of a co-feed including at least one member selected from the group consisting of pure monomer, C₅ monomers, and terpenes. Preferably, the feedstream includes 50 wt % to 85 wt % of the C₉ monomers and 50 wt % to 15 wt % of a co-feed including at least one member selected form the group consisting of pure monomer, C₅ monomers, and terpenes.

The polymerisation is carried out as a continuous process or as a batch process. The reaction may be catalytic, thermally or acid catalyzed; particular preferred catalytic processes are described in copending United Kingdom Patent Applications 9916858, 9916849 and 9916855, incorporated herein by reference. The reaction time in the batch process is typically 30 minutes to 8 hours, preferably 1 hour to 4 hours at reaction temperature and at a reaction temperature between −50° C. and 150° C., preferably between -20° C. and 100° C., and more preferably between 0° C. and 70° C. The polymerisation may be stopped by removing the catalyst from the hydrocarbon resin. The catalyst may be removed from the hydrocarbon resin by filtration. The hydrocarbon resin may be removed from a fixed bed reactor which includes the catalyst and may be stripped to remove unreacted monomers, solvents, and low molecular weight oligomers. The unreacted monomers, solvents, and low molecular weight oligomers may be recycled.

Also concerning C₅ monomer feedstreams, in addition to the reactive components, non-polymerizable components in the feed may include saturated hydrocarbons, which can be co-distilled with the unsaturated components such as pentane, cyclopentane, or 2-methylpentane. This monomer feed can be co-polymerized with C₄ or C₅ olefins or dimers as chain transfer agents. Chain transfer agents may be added to obtain resins with lower and narrower molecular weight distributions than can be prepared from using monomers alone. Chain transfer agents stop the propagation of a growing polymer chain by terminating the chain in a way which regenerates a polymer initiation site. Components which behave as chain transfer agents in these reactions include but are not limited to isobutylene, 2-methyl-1-butene, 2-methyl-2-butene or dimers or oligomers of these species. The chain transfer agent can he added to the reaction in pure form or diluted in a solvent, or it may be a component of the feed.

The preferred polymerization solvents are aromatic solvents. Typically toluene, xylenes, or light aromatic petroleum solvents. These solvents can be used fresh or recycled from the process. The solvents generally contain less than 200 ppm water, preferably less than 100 ppm water, and most preferably less than 50 ppm water. For C₅ and/or C₉ polymerisation, the preferred solvents are aromatic solvents. Generally, unreacted resin oil components are recycled through the process as solvent. In addition to the recycled solvents, toluene, xylenes, or aromatic petroleum solvents can be used. These solvents can be used fresh or recycled from the process. The solvents generally contain less than 500 ppm water, preferably less than 200 ppm water, and most preferably less than 50 ppm water. The solvent may also be the non-polymerizable component of the feed.

Concerning the polymerisation reaction conditions, a first important variable is the amount of catalyst which is used. It is preferably used at a level of 0.1 wt % to 30 wt % based on the weight of the monomer. For pure monomer resins, the concentration is preferably 0.1 to 15 wt %, more preferably 0.5 wt % to 10 wt %, and most preferably 0.5 wt % to 8 wt %. For C₅ monomers, the concentration is preferably 0.5 wt % to 30 wt %, more preferably 1 wt % to 20 wt %, and most preferably 3 wt % to 15 wt %. For C₉ monomers, the concentration is preferably 0.5 wt % to 30 wt %, more preferably 1 wt % to 20 wt %, and most preferably 3 wt % to 15 wt %.

Ethylene, α-olefin, copolymer or ethylene, α-olefin diene elastomer and hydrocarbon resin selection will depend on the particular laminar structure. Similarly the amount of resin that should be incorporated into the blend will depend on the envisioned structure. Many envisioned end uses employ from 1, more preferably 3 to 25% of resin. Particularly from 4 to 15% of resin imparts the necessary degree of tack to the elastomer. In particular from 4 to 15% preferably from 5 to 12% of resin in an elastomer provides a composition particularly useful in the production of V-belts.

The preferred aromatic content of the resin also depends upon the structure. Aromatic contents, in terms of styrene equivalents, as measured by Nuclear Magnetic Resonance Spectroscopy of from 3% to 75%, preferably 4% to 50%, more preferably 5% to 20% to provide adequate green tack to the ethylene elastomers.

After the resin is produced, it may be subsequently subjected to hydrogenation to reduce coloration and improve color stability. Resin hydrogenation is well known in the art. Any of the known processes for catalytically hydrogenating hydrocarbon resins can be used, in particular the processes of U.S. Pat. No. 5,171,793, U.S. Pat. No. 4,629,766, U.S. Pat. No. 5,502,104 and U.S. Pat. No. 4,328,090 and WO 95/12623 are suitable. Generic hydrogenation treating conditions include reactions from about 100° C.-350° C. and pressures of between five (506 kPa) and 300 atm (30390 kPa) hydrogen, for example, 10 to 275 atm. (1013 kPa to 27579 kPa). In one embodiment the temperature is in the range including 180° C. and 320° C. and the pressure is in the range including 15195 kPa and 20260 kPa hydrogen. The hydrogen-to-feed volume ratio to the reactor under standard conditions (25° C., 1 atm (101 kPa) pressure) typically can range from 20-200; for water-white resins 100-200 is preferred.

Another suitable process for hydrogenating the resin of this invention is that described in EP 0082 726. EP 0082 726 describes a process for the catalytic or thermal hydrogenation of petroleum resins using nickel-tungsten catalyst on a gamma-alumina support where in the hydrogen pressure is 1.47×10⁷-196×10⁷ Pa and the temperature is from 250-330° C. Thermal hydrogenation is usually done at 160° C. to 320° C., at a pressure of 9.8×10⁵ to 11.7×10⁵ Pa and for a period typically of 1.5 to 4 hours. After hydrogenation the reactor mixture may be flashed and further separated to recover the hydrogenated resin. Steam distillation may be used to eliminate oligomers, preferably without exceeding 325° C. resin temperature.

In a preferred embodiment, the hydrogenation is carried out by contacting the resin in the presence of hydrogen and hydrogenation catalyst metal compounds supported on porous refractory substrate particles having:

a) mean maximum diffusion path length less than or equal to twice the hydraulic radius

b) a pore volume distribution wherein;

i) pores having diameters >150,000 Å constitute greater than about 2% of the total volume

ii) pores having diameters >20,000 Å and <150,000 Å constitute greater than about 1% of the total volume, and

iii) pores having diameters >2,000 Å and <20,000 Å constitute greater than about 12% of the total volume, and,

c) A total pore volume of from 45% to 86% of the total volume of the substrate particles.

In a particularly preferred embodiment, the catalyst comprises nickel and/or cobalt on one or more of molybdenum, tungsten, alumina or silica supports. In a preferred embodiment, the amount of nickel oxide and/or cobalt oxide on the support ranges from 2 to 10 wt %. The amount of tungsten or molybdenum oxide on the support after preparation ranges from 5 to 25 wt %. Preferably, the catalyst contains 4 to 7 wt % nickel oxide and 18 to 22 wt % tungsten oxide. This process and suitable catalysts are described in greater detail in U.S. Pat. No. 5,820,749.

In another preferred embodiment, the hydrogenation may be carried out using the process and catalysts described in U.S. Pat. No. 4,629,766. In particular, nickel-tungsten catalysts on gamma-alumina are preferred.

The elastomer and the resin may be blended together in any convenient manner such as powder blending, extracting blending, calendaring and pelletizing and supplied to the manufacturer as a ready-formed blend. Superior green tack is achieved if the resin is added to the elastomer during the second half of the calendaring or mixing cycle.

The layers used in the present invention can also contain other resins, such as rosin esters derived from tall oil, gum rosin and polyterpenes, which may be incorporated during the compounding operation.

The multi-layer articles of the invention will comprise, in addition to the ethylene copolymers and terpolymers and hydrocarbon resins of the invention, any of the known natural and synthetic rubber commonly known to be useful in laminates with prior art, ethylene-containing elastomers. Examples include natural rubber, chloroprene, neoprene, butyl rubber, styrene butadiene rubber, isoprene, butadiene rubber and other polydiene rubbers.

The following other additives may be incorporated into the rubber compounds.

Vulcanising agent and/or crosslinking agent. These use the chemicals that are used to crosslink the elastomers such as sulphur in varied forms, such as powder, sulphur, precipitated sulphur, colloidal sulphur, surface-treated sulphur, and insoluble sulphur; sulphur compounds such as sulphur chloride, sulphur dichloride, morpholine disulfide, and alkylphenol disulphide; inorganic vulcanising agent other than sulphur, such as selenium and tellurium; and p-quinonedioximer; p,p-dibenzolyquinonedioxine, tetrachloro-p-benzoquinone, and poly-p-dinitrobenzene.

Alternatively organic peroxides may be used for cross-linking. Examples of suitable peroxides include tert-butylhydroperoxide, 1,1,3,3-tetramethyl-butylhydroperoxide, p-methanehydroperoxide, cumenehydroperoxide, disoproylbenzenehydroperoxide, 2,5-dimethylhexane-2,5-dihydroperoxide, di-tert-butylperoxide, dicumylperoxide, tert-butylcumylperoxide, 1,1-bis(tert-butylperoxy)cyclododecane, 2,2-bis(tert-butylperoxy)octane, 1,1-di-tert-butylperoxycyclohexane, 2,5-dimethyl-2,5-di(tert-butylperoxy)hexane, 2,5-dimethyl-2,5-(tert-butylperoxy) hexyne-3,1,3-bis(tert-butyl-peroxyisopropyl)benzene, 2,5-dimethyl-2,5-(benzoylperoxy)hexane, 1,1-bis(tert-butylperoxy)-3,3,5-trimethylcyclohexane, n-butyl-4,4-bis(tert-butylperoxy)valerate, benzoylperoxide, m-tolylperoxide, p-chlorobenzoylperoxide, 2,4-di-chlorobenzoylperoxide, tert-butylperoxyisobutyrate, tert-butylperoxy-2-ethyl-hwxanoate, tert-butylperoxybenzoate, tert-butylperoxyisopropylcarbonate, and tert-butylperoxy-allylcarbonate.

Other additives include vulcanization accelerators, such as those of guanidine type, aldehyde-amine type, aldehyde-ammonia type, thiazole type, sulphonamide type, thiourea type, thiuram type, dithiocarbonate type, xanthate type, dithiophosphate type and phosphorodithioate type. They may be used alone or in combination with one another. Accelerator activators, such as metal oxides, metal carbonates, fatty acids and derivatives thereof, and amines; and anti-scorching agent, such as organic acids, nitroso compounds, thiophthalimides, and sulphonamide derivatives.

Additionally, the additives may include age resistor, antioxidant, and antiozonant, such as those of naphthylamine type, diphenylamine type, p-phenylenediamine type, quinoline type, hydroquinone derivative, monophenol type, bis-, tris-, polyphenol type, thiobis-phenol type, hindered phenol type, phosphite ester type, thiodipropionate type, benzimidazole type, nickel dithiocarbonate type, thiourea type, triazole type, and wax; and UV absorber and photostabilizer, such as those of salicylic acid derivatives, benzophenone type, benzotriazole type, oxalanilide derivatives, hydroxybenzoate type, and hindered amine type. They may be used alone or in combination with one another.

And further the additives may include softeners, such as petroleum oil (process oil), ethylene-α-olefin oligomer, paraffin wax, liquid paraffin, white oil, petrolatum, petroleum, sultanate, gilsonite, asphalt, diene oligomer (including hydrogenated one), vegetable oil softener (caster oil, cotton seed oil, rapeseed oil, palm oil, peanut oil, pine oil, tall oil, etc), rubber substitute (vulcanized oil), fatty acid, fatty acid salt, and fatty acid ester. They may be used alone or in combination with one another.

Still further, the additives include reinforcing material and filler, such as carbon black (channel black, furnace black, thermal black or lamp black, acetylene black etc), silica (white carbon, etc), basic magnesium carbonate, calcium carbonate (e.g., light calcium carbonate, ground calcium carbonate, and surface-treated calcium carbonate), magnesium silicate (e.g., ultrafine magnesium silicate), clay, talc, wollastonite, zeolite, diatomaceous earth, silica sand, alumina sol, aluminum hydroxide, aluminum sulphate, barium sulphate, calcium sulphate, lithopone, molybdenum disulphide, rubber power, shellac, cork powder, and cellulose powder. Adhesion promoters such as zinc methacrylate may be included where the rubber layers are required to stick to other materials such as the cords used in V-belt manufacture. These additives may be used alone or in commination with one another.

Lastly, the additives, include other additives including peptizer, blowing agent, blowing promoters, slip agent, internal mould release, antifogging agent, flame retardant, built-in antistatic agent, coloring agent (pigment and dye), coupling agent, antiseptic agent, anti-mildew agent and deodorant.

The rubber composition once formed may be converted into layers by several techniques. For example, it may be calendared to form sheets or extruded to form elongated articles such as hosing.

In the production of V-belts, the rubber is first compounded with small fibers, then formed into a layer over a calendar roll. These fiber-filled layers are then interspersed with cords to form a sheet. This sheet is then cut into strips; each strip is then formed into a complete loop, the ends placed together and the system vulcanized. The incorporation of the resin in the elastomer has been found to impart sufficient green tack to the elastomer to enable it to form bonds of sufficient strength with the other layers and thus enable vulcanization without the need for additional adhesives.

In the production of tires the inclusion of the resin in the elastomer provides sufficient green tack to the elastomer that it may be used as a sidewall material in the tire. The tack imparted to the elastomer enables a layer to be produced which has sufficient adhesion that it will adhere to the other sidewall materials, such as natural rubber, chloroprene, butyl rubber and styrene/butadiene rubbers to enable the formation of an integral structure prior to vulcanization. In this way a layer of tire particularly a sidewall layer can be formed from ethylene, α-olefin diene elastomers, thus deriving the benefit of improved ozone resistance.

In the manufacture of hoses the layers are typically coextruded, the co-extrudate is cut to the desired length and subsequently vulcanized in an autoclave. Using the present invention, the coextruded layers have sufficient green tack to enable storage prior to vulcanization without damage to the co-extrudate.

The present invention is illustrated by the following Examples in which the following products were used:

An ethylene/propylene/diene elastomer containing carbon black

A standard V belt composition based on Neoprene

Escorez 5600™

Escorez 2520™ both commercially available from ExxonMobil Chemical Company, Houston, Tex.

Tel-Tak is measured with the Monsanto Tel-Tak machine and is the force required to separate two Identical Rubber Test Specimens after they have been pressed together. The process is as follows:

The rubber is first sheeted out on a rubber mill to produce sheets between 0. 15 and 0.20 cm thick.

The rubber sheet is placed on a piece of Mylar with the compound-side that was touching the roll of the mill downwards (thickness of Mylar: 0.1-0.2 mm) taking care to avoid trapping any air-bubbles between the compound-sheet and the Mylar film.

The compound is pressed firmly down onto the Mylar using an adhesives roller and cooled.

Specimens from the Mylar-side of the compound-sheet are then die-cut.

The lower grips of the Monsanto Tel-Tak assembly are moved to the down position and the desired weight placed on the Weight Support.

Available Weights are:

| | |
|---|---|
| Clamps | 8 ounces (±226.6 gr) |
| Clamps + 8 ounces | 16 ounces (±453.2 gr) |
| Clamps + 16 ounces | 24 ounces (±679.8 gr) |
| Clamps + 8 ounces + 16 ounces | 32 ounces (±906.4 gr) |

The machine is set to the desired dwell time, the protective covering(s) are removed from the test specimens.

The rubber specimens are then placed in the upper grips and stickiness measured against

Stainless steel strip in the upper grips by squeezing the spring loaded clamps and sliding

the specimen into place.

The force readings read from the force gauge are equivalent to the measured “Tack” value.

This value is in psi, as gauge readings are in ounces and the contact area in square inches. The test specimens have the following dimensions:

| | |
|---|---|
| Sample width | 6 mm or 15 mm |
| Length | 6 cm |
| Thickness | 0.15 cm |

5 samples were tested for each compound.

Blending

Blends were prepared in a Banbury mixer, operating at 120° C., to which polymer, carbon black, plasticizer, the curing package and the Escorez resin were added. A two pass blending cycle was used in which the polymer was introduced at the start and carbon black, oil and other additives introduced over a 30-minute period and the masterbatch dumped at 150° C. This was then compounded over a further 30 minutes during which the Escorez resin and the curing package were added. The product was finally dumped at 110° C.

The green strength is the maximum force (at yield) registered during the tension test carried out on an unvulcanized piece divided by the initial cross section of the test piece. The force is measured using an Instron 4502 tester connected to a computer and fitted with an electronic thickness gauge. The 5 samples were tested each being taken from a milled sheet which was conditioned at room temperature overnight.

The results were as follows:

| | | | | |
|---|---|---|---|---|
| EPDM profiled back Cpd | | 100 | 100 | 100 |
| Neoprene Standard back Cpd | 100 | | | |
| (reference) | | | | |
| Escorez 5600 | | | 10 phr | |
| Escorez 2520 | | | | 10 phr |
| Mooney viscosity (based on ASTM D | | | | |
| 1656) | | | | |
| ML (1 + 4) @ 100° C., MU | >200 | 65 | | |
| Green strength | | | | |
| (Exxon test method TS 02-10) | | | | |
| Maximum force, kN/m | 13.1 | 3.8 | | |
| Toughness, Mpa | 0.014 | 1.7 | | |
| Green strength: (MPA) after splicing | 1.4 | 0.7 | 0.95 | 0.96 |
| Tel-Tack, psi | 3.6 (25) | 2.2 (15) | 9.5 (66) | 11.8 (81.4) |

Based on the above description, we claim:

1. An article comprising a multilayer structure with at least one layer containing a blend of an ethylene, α-olefin copolymer and/or an ethylene α-olefin diene terpolymer and an aromatic-containing hydrocarbon resin.

2. The article of claim 1 in which the α-olefin has 3 to 25 carbon atoms.

3. The article of claims 1 or 2 in which the α-olefin is propylene.

4. The article of claims 1 or 2 in which the diene contains from 5 to 15 carbon atoms.

5. The article of claim 3 in which the diene contains from 5 to 15 carbon atoms.

6. The article of claims 1 or 2 in which the diene is cyclopentadiene, 1-4-hexadiene, 5-methylene-2-norbornene, 5-ethylidene-2-norbomene or vinyl norbomene.

7. The article of claim 3 in which the diene is cyclopentadiene, 1-4-hexadiene, 5-methylene-2-norbomene, 5-ethylidene-2-norbomene or vinyl norbomene.

8. The article of claim 4 in which the diene is cyclopentadiene, 1-4-hexadiene, 5-methylene-2-norbornene, 5-ethylidene-2-norbomene or vinyl norbomene.

9. The article of claim 5 in which the diene is cyclopentadiene, 1-4-hexadiene, 5-methylene-2-norbornene, 5-ethylidene-2-norbornene or vinyl norbomene.

10. The article of claims 1 or 2 in which the terpolymer contains from 0.5 to 15 wt % of the diene.

11. The article of claims 1 or 2 in which the resin containing layer contains from 1 to 25 wt % of the resin.

12. The article of claims 1 or 2 containing from 4 to 15 wt % of the resin.

13. The article of claims 1 or 2 in which the aromatic containing hydrocarbon resin contains from 3% to 75% aromaticity in terms of styrene equivalents.

14. The article of claim 9 in which the resin is a blend of an aliphatic resin and an aromatic containing resin.

15. The article of claim 10 in which the resin is totally aromatic.

16. The article of claims 1 or 2 which also contains a rosin ester, a polyterpene, or both.

17. The article of claims 1 or 2 further containing a vulcanising agent for the rubber.

18. The article of claims 1 or 2 produced by co-extrusion.

19. The article of claims 1 or 2 which has been vulcanized.

20. The article of claim 14 in which the article is a V-belt.

21. The article of claim 15 in which the article is a V-belt.

22. The article of claim 14 in which the article is a tire.

23. The article of claim 15 in which the article is a tire.

24. The article of claim 14 in which the article is a hose.

25. The article of claim 15 in which the article is a hose.

26. The article of claim 14 in which the article is sheeting.

27. The article of claim 15 in which the article is sheeting.

28. The use of an aromatic containing hydrocarbon resin for the development of green tack in ethylene α-olefin copolymer and/or ethylene, α-olefin diene copolymer rubbers.

29. A process for the production of a rubber compound in which an ethylene, α-olefin copolymer rubber and/or an ethylene, α-olefin diene terpolymer rubber is compounded with additives and an aromatic hydrocarbon resin in which the rubber is first compounded with other added additives and the aromatic hydrocarbon resin added no sooner than half way through the compounding cycle.
